(19) United States
(12) Patent Application Publication
(10) Pub. No.: US 2003/0159003 A1
(43) Pub. Date: Aug. 21, 2003

(54) Associative cache memory with replacement way information integrated into directory

(75) Inventors: Darius D. Gaskins, Austin, TX (US); James Hardage, Austin, TX (US)

Correspondence Address: James W. Huffman, Huffman Law Group, P.C., 1832 N. Cascade Ave., Colorado Springs, CO, 80907, US

(73) Assignee: IP-First, LLC, Fremont, CA (US)

(21) Appl. No.: 10/046,056

(22) Filed: Jan. 14, 2002

Related U.S. Application Data
(60) Provisional application No. 60/345,451, filed on Oct. 23, 2001.

(51) Int. Cl. G06F 12/00

(52) U.S. Cl. 711/128

(57) ABSTRACT

An associative cache memory having an integrated tag and LRU array storing pseudo-LRU information on a per way basis, obviating the need for a separate LRU array storing pseudo-LRU information on a per row basis. Each way of the integrated array stores decoded bits of pseudo-LRU information along with a tag. An encoder reads the decoded bits from all the ways of the selected row and encodes the decoded bits into standard pseudo-LRU form. The control logic selects a replacement way based on the encoded pseudo-LRU bits. The control logic then generates new decoded pseudo-LRU bits and updates only the replacement way of the selected row with the new decoded pseudo-LRU bits. Thus, the control logic individually updates only the decoded bits of the replacement way concurrent with the tag of the replacement way, without requiring update of the decoded bits in the non-replacement ways of the row.

### CROSS REFERENCE TO RELATED APPLICATIONS

This application claims priority based on U.S. Provisional Application, Serial Number ______, filed Oct. 23, 2001, entitled “L2 CACHE LRU GENERATION METHOD AND APPARATUS.”

### FIELD OF THE INVENTION

This invention relates in general to the field of associative cache memories such as those employed in microprocessors, and more particularly to storage and generation of cache line replacement algorithm information in an associative cache.

### BACKGROUND OF THE INVENTION

Memory storage in computing systems typically includes a hierarchy of different memory storage device types. The different levels of memory storage in the hierarchy possess different characteristics, particularly capacity and data access time. A level lower in the memory hierarchy indicates the level is closer to the system processor. Memory devices farthest from the processor typically have the most capacity and are the slowest. Common examples of memory devices far from the processor are electromechanical devices such as magnetic tape, compact disc, and hard disk storage devices, commonly referred to as mass storage devices, which are relatively slow, but capable of storing relatively large amounts of data.

At a next level down in the hierarchy is commonly a system memory comprising solid-state memory devices, such as dynamic random access memory (DRAM), which has access times several orders of magnitude less than mass storage devices, but which also has orders of magnitude less capacity.

At the level in the memory hierarchy closest to the processor, the processor registers excepted, is commonly found one or more levels of cache memory. Cache memories have extremely fast access time, a common example being static random access memories (SRAM). In many cases, one or more of the levels of cache memory are integrated onto the same integrated circuit as the processor. This is particularly true of modern microprocessors. Cache memories store, or “cache”, data frequently accessed by the processor from the system memory in order to provide faster access to the data when subsequently requested by the processor.

Caches commonly store data on the granularity of a cache line. An example of a common cache line size is 32 bytes. Because a cache is smaller than the system memory, when data is to be read from or written to the cache, only a portion of the system memory address of the data, commonly referred to as the index portion, or index, is used to address the cache. Consequently, multiple system memory addresses will map to the same cache index. In a direct-mapped cache, only one of the multiple system memory addresses that map to the same cache index can be cached at a time. Hence, if a program is frequently accessing two system memory locations that map to the same cache index, they will be constantly replacing one another in the cache. To alleviate this situation and improve cache effectiveness, associative caches are commonly employed.

Rather than storing a single cache line at each index as in a direct-mapped cache, an associative cache stores a row, or set, of N cache lines at each index. An associative cache allows a cache line to reside in any of the N locations in the selected row. Such a cache is referred to as an N-way associative cache, or N-way set associative cache, because there are N different ways in a selected set, or row, in which a cache line may be stored.

Because a cache line may be stored in any of the N ways of an N-way associative cache, when a new line is to be written to the cache, the associative cache must decide which of the N ways of the indexed row to write the new cache line into. That is, the associative cache must determine which of the N cache lines to replace that are already in the indexed row. Choosing the best possible way, i.e., cache line, to replace, hopefully one that will not be used in the near future, is the responsibility of the cache replacement algorithm. An example of a scheme for determining which way to replace is to replace the least recently used (LRU) way, i.e., cache line, in the row. The cache maintains information for determining which of the N ways in a given row was least recently used. In a conventional associative cache, the LRU information is stored on a per row basis in a functional block physically separate from the functional blocks that store the cache lines themselves and their associated address tags.

A conventional associative cache comprises at least three relatively large physically distinct functional blocks, or arrays. The first is the data array, which stores the actual cache lines of data, arranged as rows of N ways of cache lines as described above.

The second functional block of a conventional associative cache is the directory, also referred to as the tag array. The directory is arranged similarly to the data array with N ways. That is, the index portion of the system memory address addresses the directory to select a row of N entries. An entry in a given way of a given row of the directory stores the tag and status of a corresponding cache line in the data array. The tag plus the index forms the system memory address of the corresponding cache line, or at least an upper portion of the system memory address. When the cache is accessed, each of the tags in the selected row of the directory is compared with the system memory address and then qualified with the cache line status to determine if a cache hit has occurred. A common example of the status of the corresponding cache line is the MESI state of the cache line.

The third functional block of a conventional associative cache is the LRU array. As mentioned above, in a conventional associative cache, the LRU information is stored on a per row basis. That is, the LRU array is also addressed by the index. However, the index selects only a single entry in the LRU array, not a row of entries. That is, the single indexed entry contains the LRU information for the entire row of cache lines in the corresponding data array. A conventional associative cache employs an LRU array distinct from the data array and directory because an LRU array entry is possibly updated each time any cache line in a row is updated, whereas the data array or directory is updated on a per line basis. That is, only one of the N ways of the data array and directory are updated at a time.

There is a constant demand for the capacity of caches to increase, particularly to keep up with the constant increase in processor speeds. However, as the capacity of caches increases, ways of keeping the physical size of the caches as small as possible are needed. This is particularly true if the cache is integrated with the processor. In modern microprocessors, integrated caches can consume a substantial portion of the precious real estate of the microprocessor integrated circuit.

The fact that conventional associative caches comprise three physically distinct relatively large functional blocks works against the desire to keep caches physically as small as possible. One disadvantage of the conventional method is that it duplicates certain logic of the array, such as address decode and write logic, already present for the directory, thereby requiring additional integrated circuit or circuit board real estate. Another disadvantage is that the separate LRU array usually has a different aspect ratio than the directory and data array, which has a detrimental impact on floorplanning. That is, it is difficult to place the functional blocks on an integrated circuit die in a space-efficient manner. Another disadvantage is that the separate LRU array constitutes yet another functional block to place and route to and around on the integrated circuit or circuit board floorplan.

Therefore, what is needed is a way to generate and store associative cache line replacement information in a more space efficient manner to lessen the impact of the associative cache size and geometry.

### SUMMARY

The present invention provides an associative cache with cache line replacement information integrated into the cache directory. The cache reduces real estate consumption by being smaller, is easier to place, and is easier to route to. Accordingly, in attainment of the aforementioned object, it is a feature of the present invention to provide an N-way associative cache memory. The cache memory includes a data array, which has a first plurality of storage elements for storing cache lines arranged as M rows and N ways. The cache memory also includes a tag array, coupled to the data array, which has a second plurality of storage elements arranged as the M rows and the N ways. Each of the second plurality of storage elements stores a tag of a corresponding one of the cache lines. Each of the second plurality of storage elements also stores information used to determine which of the N ways to replace. The cache memory also includes control logic, coupled to the tag array, which reads the information from all of the N ways of a selected one of the M rows. The control logic also selects one of the N ways to replace based on the information read from all of the N ways, and updates only the information in the one of the N ways selected to replace.

In another aspect, it is a feature of the present invention to provide an N-way associative cache memory. The cache memory includes a data array, arranged as N ways, having a plurality of rows. Each of the plurality of rows stores N cache lines corresponding to the N ways. The data array also includes an index input that selects one of the plurality of rows. The cache memory also includes a directory, coupled to the data array, arranged as the N ways, having the plurality of rows. Each of the plurality of rows stores cache line replacement information. The cache line replacement information is distributed across the N ways such that each of the N ways stores only a portion of the cache line replacement information. The cache memory also includes control logic, coupled to the directory, which receives the cache line replacement information from the selected one of the plurality of rows, and generates a signal in response thereto. The signal specifies one of the N ways of the data array for replacing a corresponding one of the N cache lines in the selected one of the plurality of rows.

In another aspect, it is a feature of the present invention to provide a 4-way associative cache. The cache includes a data array. The data array has M rows. Each of the M rows has 4 ways. Each of the 4 ways in each of the M rows has a line storage element that stores a cache line. The cache also includes a directory, coupled to the data array. The directory has the M rows. Each of the M rows has the 4 ways. Each of the 4 ways in each of the M rows has a tag storage element for storing a tag of the cache line stored in a corresponding line storage element of the data array. The tag storage element also stores 2 bits of cache line replacement information. The cache also includes an encoder, coupled to the directory, that reads 8 bits including the 2 bits of cache line replacement information from each of the 4 ways of a selected one of the M rows. The encoder encodes the 8 bits into 3 bits according to a pseudo-least-recently-used encoding. The 3 bits specify which of the 4 ways of the selected one of the M rows is substantially least recently used.

In another aspect, it is a feature of the present invention to provide an associative cache memory having an integrated tag and cache line replacement information array. The cache memory includes an M row by N way array of storage elements. Each storage element stores a cache line tag and per way replacement information. The array has an input for receiving an index for selecting one of the M rows of the array. The cache memory also includes control logic, coupled to the array of storage elements, which encodes the per way replacement information from all of the N ways of the selected one of the M rows into per row replacement information. Thereby, the need for a separate cache line replacement information array of storage elements is obviated.

In another aspect, it is a feature of the present invention to provide an N-way associative cache memory. The cache memory includes a two-dimensional tag and least-recently-used (LRU) array. Each row of the array stores N tags in N ways of the row. Each row of the array also stores pseudo-LRU information. The pseudo-LRU information includes N portions distributed across the N ways of the row. The N portions collectively specify which of the N ways is substantially least recently used. Each of the N portions of the pseudo-LRU information associated with a corresponding one of the N tags is individually updateable along with the corresponding one of the N tags. The cache memory also includes control logic, coupled to the array, which receives the N portions of the pseudo-LRU information distributed across the N ways of the row. The control logic also replaces a cache line in a two-dimensional data array of the cache memory corresponding to the two-dimensional tag and LRU array. The cache line specified by the N portions is substantially least recently used in the row.

In another aspect, it is a feature of the present invention to provide a method for updating an associative cache having M rows and N ways. The method includes selecting a row from the M rows of the cache based on a cache line address, and reading cache line replacement information stored in each of the N ways of the row selected. The method also includes selecting a way for replacement of the N ways of the row selected in response to the reading, and generating new cache line replacement information in response to the reading and the selecting the way. The method also includes updating the way with the new cache line replacement information after the generating.

One advantage of the present invention is that it alleviates the need to design a separate array for the replacement algorithm bits. Another advantage is that it avoids having to duplicate most of the address decode, write logic, and other similar logic, which the prior method must do. Although the implementation shown requires 8 bits per index (2 bits/way×4 ways), whereas the prior method requires only 3 bits per index, the present inventors have observed that the sum of the duplicated array control logic and the 3 bits per index is greater than the 8 bits of storage in the present cache. Another advantage is that adding bits to the already present tag array does not create an additional array to route to and around on the floorplan.

Other features and advantages of the present invention will become apparent upon study of the remaining portions of the specification and drawings.

### BRIEF DESCRIPTION OF THE DRAWINGS

FIG. 1 is a block diagram of a conventional 4-way associative cache memory.

FIG. 2 is a block diagram of the control logic of the conventional cache of FIG. 1.

FIG. 3 is a flow chart illustrating how the conventional cache of FIG. 1 operates to replace a cache line.

FIG. 4 is a block diagram of a 4-way associative cache memory according to the present invention.

FIG. 5 is a block diagram of the control logic of the cache memory of FIG. 4 according to the present invention.

FIG. 6 is a flowchart illustrating how the cache memory of FIG. 4 operates to replace a cache line according to the present invention.

### DETAILED DESCRIPTION

The present invention will be better understood by first describing a related art associative cache that does not have the benefit of the features of the present invention.

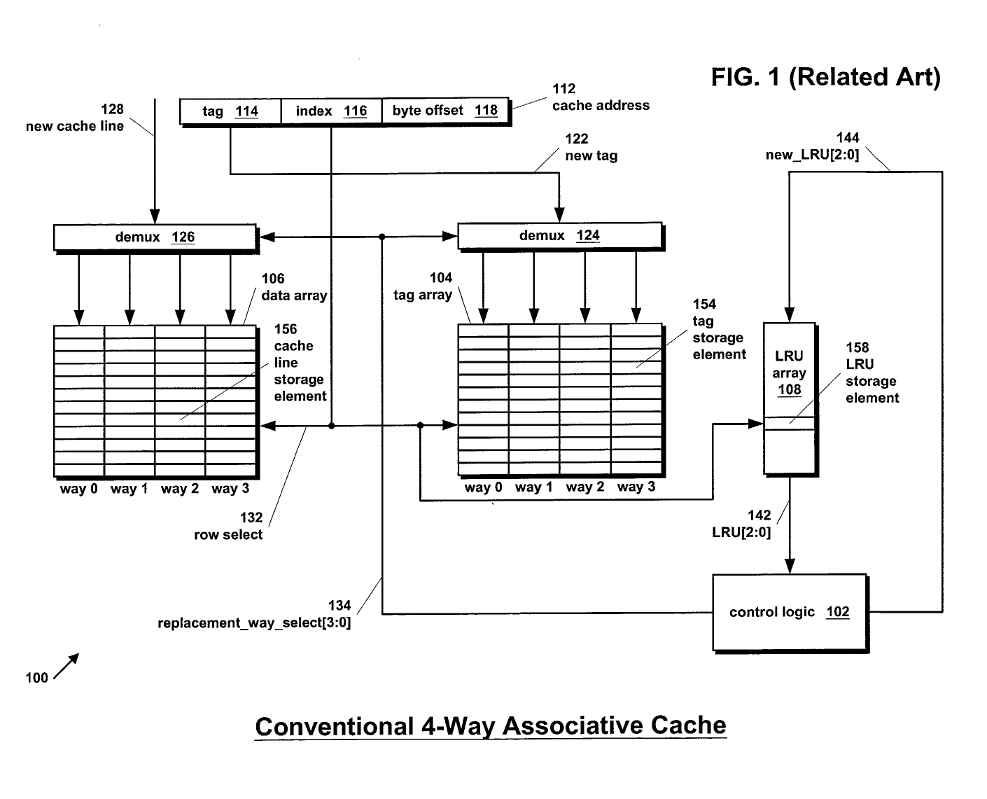

Referring now to FIG. 1, a block diagram of a conventional 4-way associative cache memory 100 is shown. A new cache line 128 is provided for writing into the cache 100 during a cache 100 write operation. A cache address 112 specifying a cache line to be read or written is provided to the cache 100. In particular, the cache address 112 of the new cache line 128 is used to write new cache line 128 into the cache 100. The cache address 112 comprises a tag portion 114, an index portion 116, and a byte offset portion 118. The tag 114 comprises the most significant bits of the cache address 112. The index 116 comprises the middle significant bits of the cache address 112, and the byte offset 118 comprises the least significant bits of the cache address 112.

The cache 100 includes a data array 106. The data array 106 comprises a plurality of storage elements for storing cache lines, exemplified by cache line storage element 156 as shown. The storage elements 156 are arranged as a two-dimensional array of rows and columns. The columns are referred to as ways. Cache 100 comprises 4 ways, denoted way 0, way 1, way 2, and way 3, as shown. A cache line is stored in a cache line storage element 156 at the intersection of a row and a way. The index 116 of the cache address 112 is provided to data array 106 on row select signal 132. Row select signal 132 selects one of the rows of the data array 106 to write the new cache line 128 into. A cache line is associative along all of the 4 ways in a row, or set. That is, it is permissible to write a cache line to any of the 4 ways of a row of the data array 106 selected by row select signal 132. The associativity increases the hit rate and effectiveness of the cache 100 above a direct mapped cache in most applications.

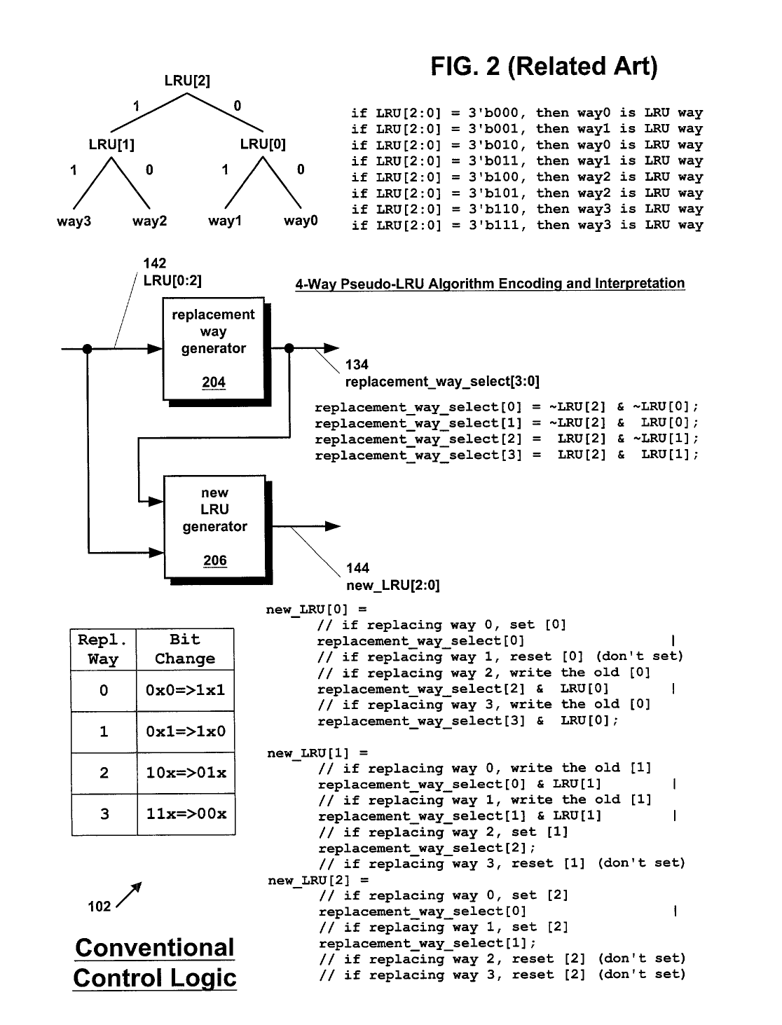

The cache 100 also includes a demultiplexer 126, coupled to data array 106. Demultiplexer 126 is controlled by a replacement_way_select[3:0] signal 134 that selects one of the 4 ways of the data array 106 to write the new cache line 128 into. Demultiplexer 126 receives the new cache line 128 and selectively provides the new cache line 128 to one of the 4 ways of the data array 106 specified by the replacement_way_select[3:0] signal 134. The replacement_way_select[3:0] signal 134 is generated by control logic 102 as will be specified with respect to FIG. 2 below. Hence, the new cache line 128 is written into a storage element 156 of a way selected by replacement_way_select[3:0] signal 134 of a row selected by row select signal 132.

The cache 100 also includes a tag array 104. The tag array 104 is also referred to as directory 104. The tag array 104 comprises a plurality of storage elements for storing tags, exemplified by tag storage element 154 as shown. Tag array 104 is arranged similarly to data array 106 as a two-dimensional array with the same number of rows and ways as data array 106. A tag of a cache line is stored in a tag storage element 154 at the intersection of a row and a way corresponding to a cache line storage element 156 located at the same row and way of the data array 106. Row select signal 132 is also provided to tag array 104. The tag 114 of the cache address 112 is provided on new tag signal 122. Row select signal 132 selects one of the rows of the tag array 104 to write the new tag 122 into. The tag is read during a cache 100 read operation to determine whether a cache hit has occurred. In addition to storing the tag of a cache line, the tag storage element 154 may also store cache status information, such as MESI (Modified, Exclusive, Shared, Invalid) state information, or cache status information associated with other cache coherency algorithms. A cache hit occurs if the tag in the tag storage element 154 matches the tag 114 of the cache address 112 and the line has the required validity.

The cache 100 also includes a second demultiplexer 124, coupled to tag array 104. Demultiplexer 124 is also controlled by replacement_way_select[3:0] signal 134 that selects one of the 4 ways of the tag array 104 to write the new tag 122 into. Demultiplexer 124 receives the new tag 122 and selectively provides the new tag 122 to one of the 4 ways of the tag array 104 specified by replacement_way_select[3:0] signal 134. Hence, the new tag 122 is written into a storage element 154 of a way selected by replacement_way_select[3:0] signal 134 of a row selected by row select signal 132.

The cache 100 also includes an LRU array 108. The LRU array 108 comprises a plurality of storage elements for storing LRU information, exemplified by LRU storage element 158 as shown. LRU array 108 is arranged as a one-dimensional array with the same number of rows as data array 106 and tag array 104. LRU information is stored in an LRU storage element 158 in a row corresponding to a cache line storage element 156 located at the same row and way of the data array 106. Row select signal 132 is also provided to the LRU array 108. LRU array 108 receives new LRU information on new LRU[2:0] signal 144. The new LRU information describes which of the 4 ways of the row selected by row select signal 132 is least recently used. The new LRU information is written into the storage element 158 of a row selected by row select signal 132. The new_LRU[2:0] signal 144 is generated by control logic 102 as will be described with respect to FIG. 2 below. The LRU array 108 also provides LRU information from a row in the LRU array 108 selected by row select signal 132 and provides the LRU information on LRU[2:0] signal 142 to control logic 102. Control logic 102 uses the LRU information received on LRU[2:0] signal 142 to generate the replacement_way_select[3:0] signal 134 and the new_LRU[2:0] signal 144 as will now be described.

Referring now to FIG. 2, a block diagram of the control logic 102 of the conventional cache 100 of FIG. 1 is shown. Also shown are the equations describing the combinational logic comprised in each of the blocks of FIG. 2. Also shown is a tree diagram and bit encoding describing the encoding of the 3 bits of encoded information of a 4-way pseudo-LRU algorithm as is well known in the art. The pseudo-LRU algorithm is a popular replacement algorithm for associative caches because it uses fewer bits than true LRU, is easier to update, but has most of the true LRU qualities. Pseudo-LRU attempts to keep track of the least recently used cache line for a selected row. For brevity, pseudo-LRU information and related signals described herein are referred to as LRU rather than pseudo-LRU. The 3 bits of LRU information stored in the LRU array 108 provided on the LRU[2:0] signal 142 to control logic 102 of FIG. 1 are encoded according to the tree shown in FIG. 2.

The control logic 102 includes a replacement way generator 204. The replacement way generator 204 receives LRU[2:0] signal 142 of FIG. 1 from the LRU array 108 of FIG. 1.

The replacement way generator 204 selects a replacement way based on the following rules also shown in FIG. 2.

if LRU[2:0]=3′b000, then way0 is LRU way

if LRU[2:0]=3′b001, then way1 is LRU way

if LRU[2:0]=3′b010, then way0 is LRU way

if LRU[2:0]=3′b011, then way1 is LRU way

if LRU[2:0]=3′b100, then way2 is LRU way

if LRU[2:0]=3′b101, then way2 is LRU way

if LRU[2:0]=3′b110, then way3 is LRU way

if LRU[2:0]=3′b111, then way3 is LRU way

The replacement way generator 204 generates replacement_way_select[3:0] signal 134 in response to LRU[2:0] signal 142 according to the following equations also shown in FIG. 2.

replacement_way_select[0]=˜LRU[2] &˜LRU[0];

replacement_way_select[1]=˜LRU[2]&LRU[0];

replacement_way_select[2]=LRU[2] &˜LRU[1];

replacement_way_select[3]=LRU[2] &LRU[1];

The control logic 102 also includes a new LRU generator 206. The new LRU generator 206 receive s LRU[2:0] signal 142 from the LRU array 108. The new LRU generator 206 also receives the replacement_way_select[3:0] signal 134 from the replacement way generator 204. The new LRU generator 206 generates new LRU information based on the following rules shown in Table 1 and also shown in FIG. 2.

TABLE 1

| Repl. | Bit |
|---|---|
| Way | Change |
| 0 | 0 × 0 => 1 × 1 |
| 1 | 0 × 1 => 1 × 0 |
| 2 | 10× => 01× |
| 3 | 11× => 00× |

The rules of Table 1 are further explained as follows. If way0 is the replacement way, then steer away from way0, since it is now the most recently used, by setting LRU[2], not changing LRU[1], and setting LRU[0]. If way1 is the replacement way, then steer away from way1, since it is now the most recently used, by setting LRU[2], not changing LRU[1], and resetting LRU[0]. If way2 is the replacement way, then steer away from way2, since it is now the most recently used, by resetting LRU[2], setting LRU[1], and not changing LRU[0]. If way3 is the replacement way, then steer away from way3, since it is now the most recently used, by resetting LRU[2], resetting LRU[l], and not changing LRU[0].

The new LRU generator 206 generates the new_LRU[2:0] signal 144 of FIG. 1 according to the following equations also shown in FIG. 2.

new_LRU [0] =

| // if replacing way 0, set [0] | |
|---|---|
| replacement_way_select [0 ] | \| |
| // if replacing way 1, reset [0] (don't set) | |
| // if replacing way 2, write the old [0] | |
| replacement_way_select [2] & LRU [0] | \| |
| // if replacing way 3, write the old [0] | |
| replacement_way_select [3] & LRU [0]; | |

new_LRU [1] =

| // if replacing way 0, write the old [1] | |
|---|---|
| replacement_way_select [0] & LRU [1] | \| |
| // if replacing way 1, write the old [1] | |
| replacement_way_select [1] & LRU [1] | \| |

// if replacing way 2, set [1]
replacement_way_select [2];
// if replacing way 3, reset [1] (don't set)

new_LRU [2] =

| // if replacing way 0, set [2] | |
|---|---|
| replacement_way_select [0] | \| |

// if replacing way 1, set [2]
replacement_way_select [1];
// if replacing way 2, reset [2] (don't set)
// if replacing way 3, reset [2] (don't set)

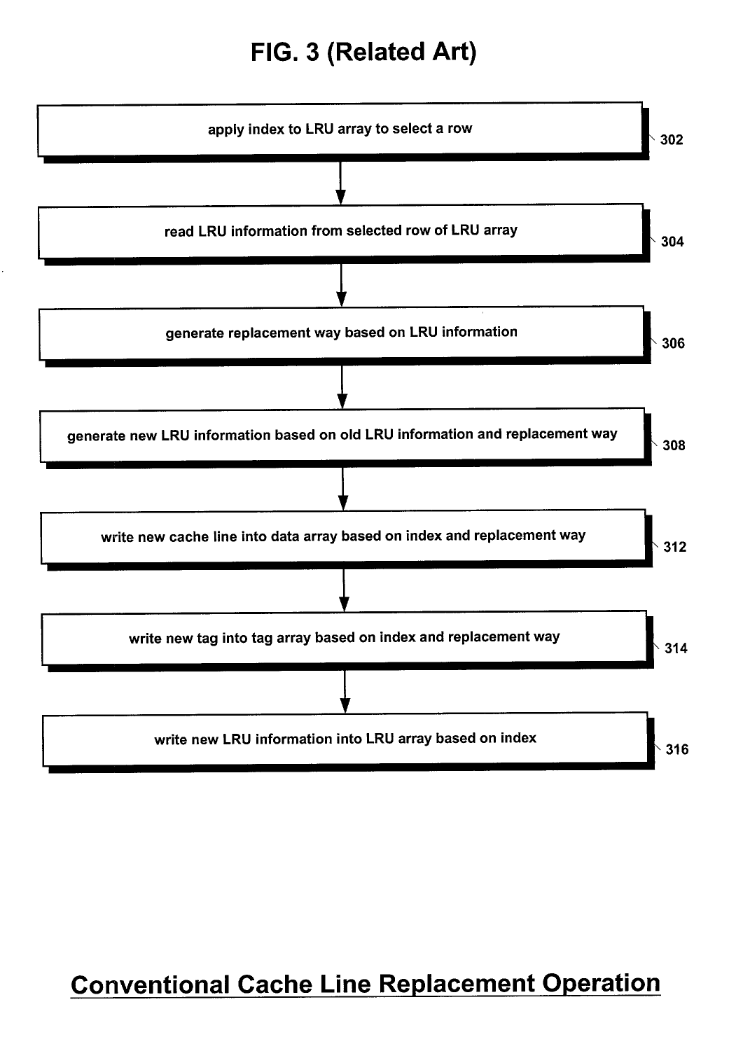

Referring now to FIG. 3, a flow chart illustrating how the conventional cache 100 of FIG. 1 operates to replace a cache line is shown. Flow begins at block 302.

At block 302, the index 116 of FIG. 1 is applied via row select signal 132 of FIG. 1 to the LRU array 108 of FIG. 1 to select a row of the LRU array 108. Flow proceeds from block 302 to block 304.

At block 304, the LRU information is read from the LRU storage element 158 of the selected row of the LRU array 108 and provided to the control logic 102 of FIG. 1 via LRU[2:0] signals 142. Flow proceeds from block 304 to block 306.

At block 306, the replacement way generator 204 of FIG. 2 generates the replacement_way_select[3:0] signal 134 as described with respect to FIG. 2. Flow proceeds from block 306 to block 308.

At block 308, the new LRU generator 206 of FIG. 2 generates the new LRU[2:0] signal 144 of FIG. 1 as described with respect to FIG. 2. Flow proceeds from block 308 to block 312.

At block 312, the new cache line 128 of FIG. 1 is written into the cache line storage element 156 of FIG. 1 selected by the row select signal 132 and the replacement_way_select[3:0] signal 134. Flow proceeds from block 312 to block 314.

At block 314, the new tag 122 of FIG. 1 is written into the tag storage element 154 of FIG. 1 selected by the row select signal 132 and the replacement_way_select[3:0] signal 134. Flow proceeds from block 314 to block 316.

At block 316, the new LRU information provided on new_LRU[2:0] signal 144 is written into the LRU storage element 158 of FIG. 1 selected by the row select signal 132. Flow ends at block 316.

As may be readily observed from FIGS. 1 through 3, a conventional associative cache employs a separate array for LRU storage from the tag array and data array. The reason conventional associative caches use a separate LRU array is that the LRU information for a row is possibly updated each time any of the ways, i.e., cache line and tag, in a selected row is updated. In contrast, a tag array is updated on a per way, i.e., per tag, basis. That is, only one of the N ways of the tag array is updated at a time. As discussed above, there are definite disadvantages to having separate physically distinct data, tag, and LRU arrays. Hence, it is desirable to have a single array of storage elements that stores both tag and way replacement information as provided by the present invention. However, because tags are updated on a per way basis, a solution is required which allows way replacement information to be updated on a per way basis, also.

The present invention provides an associative cache that integrates the LRU array into the tag array. The normal LRU information, i.e., the per row LRU or row-specific information, is decoded to a way-specific or per way basis specific to the way that will be replaced. This enables just the per way LRU information to be stored into the tag array along with the individual tag of the cache line being written, i.e., on a per way basis. That is, the per way LRU information may be written to an individual way in the tag array without having to write to all the ways in the row. In order to determine which way of a selected row is to be replaced, the per way LRU information is read from all the ways and encoded back to the per row LRU form. The decoding and encoding steps advantageously enable integration of the tag and LRU arrays. As will be seen, the storing of the per way decoded LRU bits requires more storage than the normal per row LRU bits, but has the advantage of obviating the need for a separate LRU array.

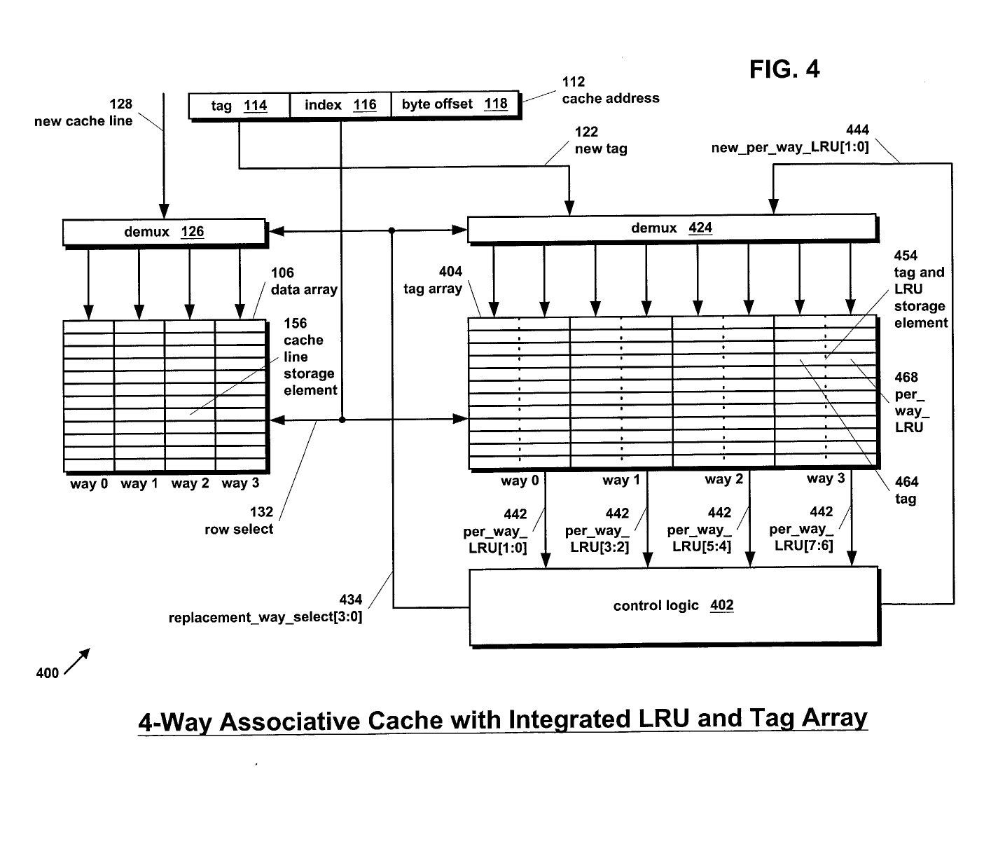

Referring now to FIG. 4, a block diagram of a 4-way associative cache memory 400 according to the present invention is shown. Elements of cache 400 numbered the same as elements of cache 100 of FIG. 1 function similarly unless otherwise specified. In particular, cache 400 does not include a separate LRU array as does the conventional cache 100 of FIG. 1. In contrast, the LRU information is integrated into a tag array 404 of cache 400.

Cache 400 includes a data array 106 and demultiplexer 126 similar to like numbered items described with respect to FIG. 1. In one exemplary embodiment, the data array 106 is capable of storing 64 KB of data. Each cache line comprises 32 bytes. Hence, each row is capable of storing 128 bytes. Consequently, the data array 106 comprises 512 rows.

Cache 400 includes a tag array 404. The tag array 404 is arranged similarly to tag array 104 of FIG. 1; however, a plurality of storage elements of tag array 404, exemplified by tag and LRU storage element 454 as shown, are configured to store not only a tag 464, but also per way LRU information 468. Tag array 404 is arranged similarly to data array 106 as a two-dimensional array with the same number of rows and ways as data array 106. A cache line tag 464 is stored in a tag and LRU storage element 454 at the intersection of a row and a way corresponding to a cache line storage element 156 located at the same row and way of the data array 106. Row select signal 132 is also provided to tag array 404. The tag portion 114 of the cache address 112 is provided on new tag signal 122. Row select signal 132 selects one of the rows of the tag array 404 to write the new tag 122 into. The tag 114 is compared during a cache 400 read operation to determine whether a cache hit has occurred. In addition to storing the cache line tag 464 and per way LRU information 468, the tag storage element 454 may also store cache status information, such as MESI (Modified, Exclusive, Shared, Invalid) state information, or cache status information associated with other cache coherency algorithms.

In one embodiment, the per way LRU information 468 comprises 2-bits. The per way LRU information 468 coding is different than the LRU information stored in the LRU array 108 of FIG. 1 because the per way LRU information 468 stored in tag array 404 is updated on a per way basis, whereas the LRU information stored in LRU array 108 is updated on a per row basis. Although the per way LRU information 468 is written on a per way basis, it is read on a per row basis, as are the tags in the selected row during a read of the tag array 404. That is, the per way LRU information 468 from each of the four ways of the selected row are read in order to determine which of the four ways is least recently used. The encoding and decoding of the per way LRU information 468 will be described in detail below.

The cache 400 also includes a second demultiplexer 424, coupled to tag array 404. Demultiplexer 424 is also controlled by a replacement_way_select[3:0] signal 434 that selects one of the 4 ways of the tag array 404 to write the new tag 122 into. Demultiplexer 424 receives the new tag 122 and selectively provides the new tag 122 to one of the 4 ways of the tag array 404 specified by the replacement_way_select[3:0] signal 434. Hence, the new tag 122 is written into a storage element 454 of a way selected by replacement_way_select[3:0] signal 434 of a row selected by row select signal 132.

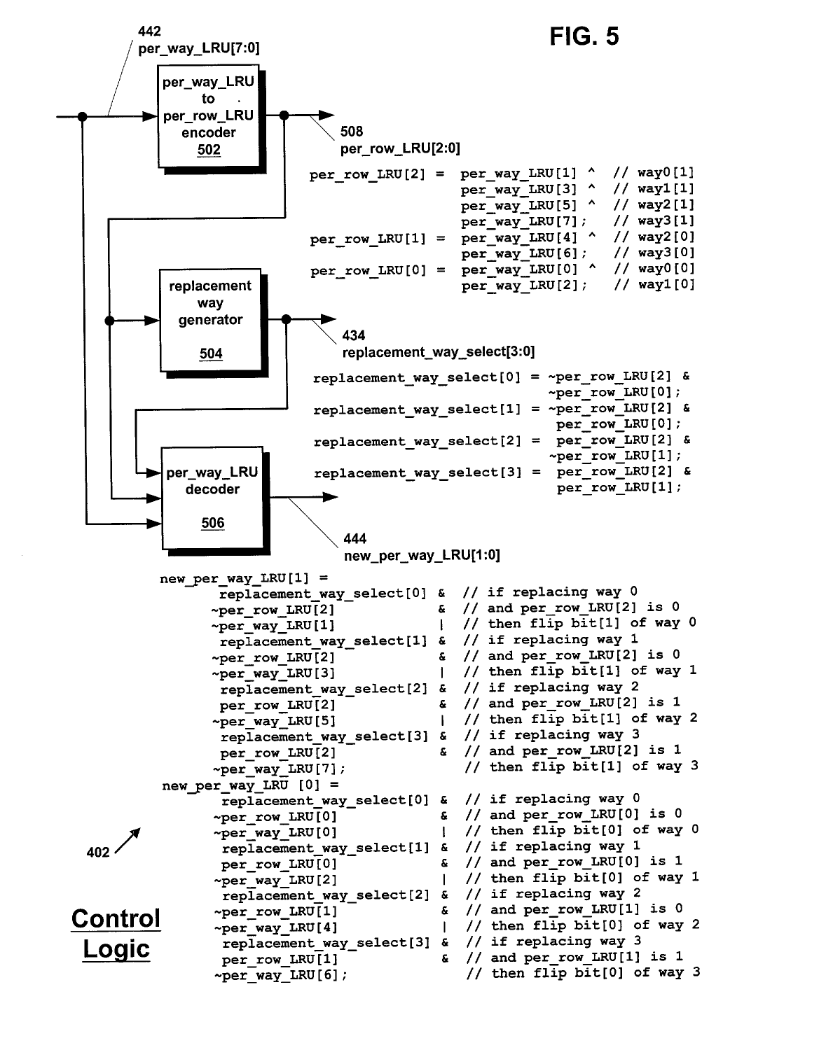

In addition, demultiplexer 424 receives a signal new_per_way_LRU[1:0]444 generated by control logic 402. Demultiplexer 424 receives the new_per_way_LRU[1:0] signal 444 and selectively provides the new_per_way_LRU[1:0] signal 444 to one of the 4 ways of the tag array 404 specified by the replacement_way_select[3:0] signal 434. Hence, the new_per_way_LRU[1:0] signal 444 is written into a storage element 454 of a way selected by replacement_way_select[3:0] signal 434 of a row selected by row select signal 132 along with the new tag 122. Control logic 402 generates new_per_way_LRU[1:0] signal 444 in response to the 2 bits of per_way_LRU information 468 from all 4 of the ways of a selected row of tag array 404 provided on per_way_LRU[7:0] signal 442 to control logic 402 as will be described below with respect to FIG. 5. The per_way_LRU information 468 from way 0, way 1, way 2, and way 3 of tag array 404 are provided on signals per way_LRU[1:0] 442, per_way_LRU[3:2] 442, per way_LRU[5:4] 442, and per_way_LRU[7:6] 442, respectively, as shown. Control logic 402 generates replacement_way_select[3:0] signal 434 based on per_way_LRU[7:0] signal 442 as will be described below with respect to FIG. 5.

Referring now to FIG. 5, a block diagram of the control logic 402 of the cache memory 400 of FIG. 4 according to the present invention is shown. Also shown are the equations describing the combinational logic comprised in each of the blocks of FIG. 5.

Control logic 402 comprises a per_way_LRU-to-per_row_LRU encoder 502. The per_way_LRU-to-per_row_LRU encoder 502 receives per_way_LRU[7:0] signal 442 of FIG. 4 and generates per_row_LRU[2:0] signal 508 in response thereto according to the following equations also shown in FIG. 5.

| | | | |
|---|---|---|---|
| per_row_LRU [2] = | per_way_LRU [1] | \hat{ } | // way0 [1] |
| | per_way_LRU [3] | \hat{ } | // way1 [1] |
| | per_way_LRU [5] | \hat{ } | // way2 [1] |
| | per_way_LRU [7]; | | // way3 [1] |
| per_row_LRU [1] = | per_way_LRU [4] | \hat{ } | // way2 [0] |
| | per_way_LRU [6]; | | // way3 [0] |
| per_row_LRU [0] = | per_way_LRU [0] | \hat{ } | // way0 [0] |
| | per_way_LRU [2]; | | // way1 [0] |

As may be observed from the per way_LRU-to-per_row_LRU encoder 502 equations, the encoder 502 performs binary exclusive-OR operations on the per_way_LRU[7:0] signal 442 in a predetermined manner to encode the per way LRU information on signal 442 into the standard 3-bit pseudo-LRU form which is described with respect to FIG. 2.

Control logic 402 also comprises a replacement way generator 504 similar to replacement way generator 204 of FIG. 2. The replacement way generator 504 receives per_row_LRU[2:0] signal 508 and generates replacement_way_select[3:0] signal 434 of FIG. 4 in response thereto according to the following equations also shown in FIG. 5.

| | |
|---|---|
| replacement_way_select [0] = | ˜per_row_LRU [2] & |
| | ˜per_row_LRU [0]; |
| replacement_way_select [1] = | ˜per_row_LRU [2] & |
| | per_row_LRU [0]; |
| replacement_way_select [2] = | per_row_LRU [2] & |
| | ˜per_row_LRU [1]; |
| replacement_way_select [3] = | per_row_LRU [2] & |
| | per_row_LRU [1]; |

Control logic 402 also comprises a per way LRU decoder 506. The decoder 506 receives per_way_LRU[7:0] signal 442, per_row_LRU[2:0] signal 508, and replacement_way_select[3:0] signal 434, and generates new_per_way_LRU[1:0] signal 444 of FIG. 4 in response thereto according to the following equations.

new_per_way_LRU [1] =

| | | |
|---|---|---|
| replacement_way_select [0] | & | // if replacing way 0 |
| ˜per_row_LRU [2] | & | // and per_row_LRU [2] is 0 |
| ˜per_way_LRU [1] | \| | // then flip bit [1] of way 0 |
| replacement_way_select [1] | & | // if replacing way 1 |
| ˜per_row_LRU [2] | & | // and per_row_LRU [2] is 0 |
| ˜per_way_LRU [3] | \| | // then flip bit [1] of way 1 |
| replacement_way_select [2] | & | // if replacing way 2 |
| per_row_LRU [2] | & | // and per_row_LRU [2] is 1 |
| ˜per_way_LRU [5] | \| | // then flip bit [1] of way 2 |
| replacement_way_select [3] | & | // if replacing way 3 |
| per_row_LRU [2] | & | // and per_row_LRU [2] is 1 |
| ˜per_way_LRU [7]; | | // then flip bit [1] of way 3 |

new_per_way LRU [0] =

| | | |
|---|---|---|
| replacement_way_select [0] | & | // if replacing way 0 |
| ˜per_row_LRU [0] | & | // and per_row_LRU [0] is 0 |
| ˜per_way_LRU [0] | \| | // then flip bit [0] of way 0 |
| replacement_way select [1] | & | // if replacing way 1 |
| per_row_LRU [0] | & | // and per_row_LRU [0] is 1 |
| ˜per_way_LRU [2] | \| | // then flip bit [0] of way 1 |
| replacement_way_select [2] | & | // if replacing way 2 |
| ˜per_row_LRU [1] | & | // and per_row_LRU [1] is 0 |
| ˜per_way_LRU [4] | \| | // then flip bit [0] of way 2 |
| replacement_way_select [3] | & | // if replacing way 3 |
| per_row_LRU [1] | & | // and per_row_LRU [1] is 1 |
| ˜per_way_LRU [6]; | | // then flip bit [0] of way 3 |

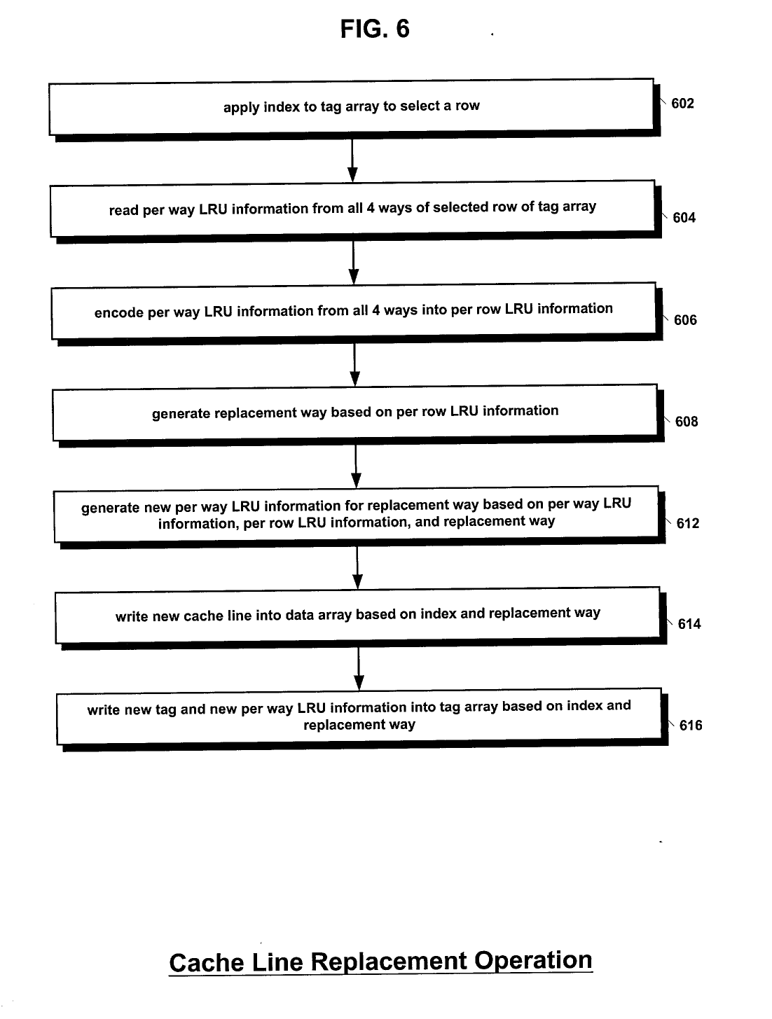

As may be observed from the per_way_LRU decoder 506 equations, the decoder 506 decodes the per_row_LRU[2:0] signal 508 information based on the way selected for replacement to generate new per way LRU information that, when read collectively along with the other per way LRU information 468 of FIG. 4 from the other 3 ways in the selected row will enable the per_way_LRU-to-per_row_LRU encoder 502 to encode back to the standard pseudo-LRU form, as will be described below with respect to FIG. 6.

Referring now to FIG. 6, a flowchart illustrating how the cache memory 400 of FIG. 4 operates to replace a cache line according to the present invention is shown. Flow begins at block 602.

At block 602, the index 116 of FIG. 4 is applied via row select signal 132 of FIG. 4 to the tag array 404 of FIG. 4 to select a row of the tag array 404. Flow proceeds from block 602 to block 604.

At block 604, the per_way_LRU information 468 is read from the selected row of the tag array 404 and provided to the control logic 402 of FIG. 4 via per_way_LRU[7:0] signal 442. Flow proceeds from block 604 to block 606.

At block 606, per_way_LRU-to-per_row_LRU encoder 502 of FIG. 5 encodes per_way_LRU[7:0] signal 442, which in block 604 was read from each of the four ways of the row of the tag array 404 selected by row select signal 132, to per_row_LRU[2:0] signal 508 as described with respect to FIG. 5. Flow proceeds from block 606 to block 608.

At block 608, the replacement way generator 504 of FIG. 5 generates the replacement_way_select[3:0] signal 434 as described with respect to FIG. 5. Flow proceeds from block 608 to block 612.

At block 612, per_way_LRU decoder 506 of FIG. 5 generates new_per_way_LRU[1:0] signal 444 of FIG. 4 for the replacement way specified on replacement_way_select[3:0] signal 434 based on per_way_LRU[7:0] signal 442, per_row_LRU[2:0] signal 508, and replacement_way_select[3:0] signal 434 as described with respect to FIG. 5. Flow proceeds from block 612 to block 614.

At block 614, the new cache line 128 of FIG. 4 is written into the cache line storage element 156 of FIG. 4 selected by the row select signal 132 and the replacement_way_select[3:0] signal 434. Flow proceeds from block 614 to block 616.

At block 616, the new tag 122 of FIG. 4 and the new_per_way₁₃ LRU[1:0] information 444 of FIG. 4 is written into the tag and LRU storage element 454 selected by the row select signal 132 and the replacement_way_select[3:0] signal 434. Flow ends at block 616.

As may be observed from the embodiment of FIGS. 4 through 6, the pseudo-LRU information that is distributed across the row, but updateable on a per way basis, is updated when a way is replaced. The embodiment is particularly suitable to a victim cache. However, the embodiment is readily adaptable to caches with other LRU update policies. For example, the pseudo-LRU information may also be updated upon other events, such as upon load hits. In such an embodiment, the replacement way generator becomes an “accessed way generator,” that selects the accessed way on a load hit (or other LRU updating event) and selects the least recently used way on a cache line replacement. In addition, the replacement way generator may take into account other factors to use in selecting a way to replace, such as choosing to replace an invalid way if one exists in the selected row rather than choosing the least recently used way.

Although the present invention and its objects, features, and advantages have been described in detail, other embodiments are encompassed by the invention. For example, the present invention is adaptable to associative caches with different numbers of ways, rows, and cache line sizes. Additionally, the notion of integrating the LRU array with the tag array and encoding and decoding replacement algorithm information accordingly may be employed with other replacement algorithms besides the pseudo-LRU algorithm. Furthermore, the present invention may be employed in instruction caches, data caches, or combined data/instruction caches. Finally, the present invention is not limited to caches integrated onto the same integrated circuit as the processor, but may also be employed in discrete caches.

Those skilled in the art should appreciate that they can readily use the disclosed conception and specific embodiments as a basis for designing or modifying other structures for carrying out the same purposes of the present invention without departing from the spirit and scope of the invention as defined by the appended claims.

We claim:

1. An N-way associative cache memory, comprising:
a data array, comprising a first plurality of storage elements for storing cache lines arranged as M rows and N ways;
a tag array, coupled to said data array, comprising a second plurality of storage elements arranged as said M rows and said N ways, each of said second plurality of storage elements for storing a tag of a corresponding one of said cache lines, wherein each of said second plurality of storage elements is also configured to store information used to determine which of said N ways to replace; and
control logic, coupled to said tag array, configured to read said information from all of said N ways of a selected one of said M rows, to select one of said N ways to replace based on said information read from all of said N ways, and to update only said information in said one of said N ways selected to replace.

2. The cache memory of claim 1, wherein said control logic is configured to update said tag in said one of said N ways selected to replace concurrently with said information.

3. The cache memory of claim 1, wherein said control logic is further configured to update one of said cache lines corresponding to said tag in said one of said N ways selected to replace substantially concurrently with said information.

4. The cache memory of claim 1, wherein said control logic is configured to determine from said information read from said all of said N ways collectively which of said N ways of said selected one of said M rows is substantially least recently used.

5. The cache memory of claim 4, wherein said control logic is configured to encode said information read from said all of said N ways into a plurality of bits specifying which of said N ways of said selected one of said M rows is substantially least recently used according to a pseudo-least-recently-used encoding.

6. The cache memory of claim 5, wherein N is 4.

7. The cache memory of claim 6, wherein said information stored in each of said second plurality of storage elements comprises 2 bits.

8. The cache memory of claim 7, wherein said plurality of bits specifying which of said N ways of said selected one of said M rows is substantially least recently used according to a pseudo-least-recently-used encoding comprises 3 bits.

9. The cache memory of claim 4, wherein said control logic is configured to select said one of said N ways to replace based on determining from said information read from said all of said N ways collectively which of said N ways of said selected one of said M rows is substantially least recently used.

10. The cache memory of claim 9, wherein said control logic is configured to generate new information for updating only said information in said one of said N ways selected to replace.

11. The cache memory of claim 10, wherein said control logic generates said new information based on which of said N ways of said selected one of said M rows is substantially least recently used.

12. The cache memory of claim 11, wherein said control logic generates said new information based further on said information in said one of said N ways selected to replace.

13. The cache memory of claim 10, wherein said control logic generates said new information based further on said one of said N ways selected to replace.

14. The cache memory of claim 13, wherein said control logic generates said new information based further on said information in said one of said N ways selected to replace.

15. The cache memory of claim 4, wherein said information from any one of said N ways of said selected one of said M rows does not individually specify which of said N ways is substantially least recently used.

16. The cache memory of claim 4, wherein said control logic is configured to determine from said information read from said all of said N ways collectively which of said N ways of said selected one of said M rows is substantially least recently used by performing an exclusive-OR operation in a predetermined manner on said information read from said all of said N ways.

17. An N-way associative cache memory, comprising:
a data array, arranged as N ways, comprising a plurality of rows, each of said plurality of rows configured to store N cache lines corresponding to said N ways, and an index input for selecting one of said plurality of rows;
a directory, coupled to said data array, arranged as said N ways, comprising said plurality of rows, each of said plurality of rows configured to store cache line replacement information, wherein said cache line replacement information is distributed across said N ways such that each of said N ways stores only a portion of said cache line replacement information; and
control logic, coupled to said directory, configured to receive said cache line replacement information from said selected one of said plurality of rows, and to generate a signal in response thereto, said signal specifying one of said N ways of said data array for replacing a corresponding one of said N cache lines in said selected one of said plurality of rows.

18. The cache memory of claim 17, wherein each of said plurality of rows of said directory is configured to store N tags, said N tags specifying at least a portion of an address of a corresponding one of said N cache lines stored in said data array.

19. The cache memory of claim 17, wherein each of said plurality of rows of said directory is configured to store N status information, said N status information specifying cache status of a corresponding one of said N cache lines stored in said data array.

20. The cache memory of claim 19, wherein said N status information comprises information specifying whether said corresponding one of said N cache lines stored in said data array is modified, exclusively held, shared, or invalid.

21. The cache memory of claim 17, wherein said cache line replacement information comprises information used for determining which of said N cache lines in said one of said plurality of rows selected by said index input is least recently used.

22. The cache memory of claim 21, wherein said control logic comprises an encoder for encoding said cache line replacement information into an encoded form of said cache line replacement information.

23. The cache memory of claim 22, wherein said encoded form of said cache line replacement information comprises information for specifying which of said N cache lines in said one of said plurality of rows selected by said index input is least recently used according to a pseudo-least recently used encoding.

24. The cache memory of claim 22, wherein said encoder encodes said cache line replacement information into said encoded form of said cache line replacement information by exclusive-ORing predetermined subsets of said cache line replacement information to generate said encoded form.

25. The cache memory of claim 17, wherein said control logic is further configured to generate updated cache line replacement information for storage in said selected one of said plurality of rows of said directory.

26. The cache memory of claim 25, wherein said control logic generates said updated cache line replacement information in response to said signal specifying one of said N ways.

27. The cache memory of claim 25, wherein said portion of said cache line replacement information stored in each of said N ways is individually updateable.

28. The cache memory of claim 27, wherein said updated cache line replacement information comprises information for updating only said portion of said cache line replacement information corresponding to said one of said N ways specified by said signal.

29. The cache memory of claim 17, wherein said N is 4.

30. The cache memory of claim 17, wherein said control logic comprises encoding logic for receiving said portion of said cache line replacement information from each of said N ways of said selected one of said plurality of rows, and encoding same into encoded information specifying which of said N ways of said selected one of said plurality of rows is substantially least recently used.

31. A 4-way associative cache, comprising:
a data array, having M rows, each of said M rows having 4 ways, each of said 4 ways in each of said M rows having a line storage element for storing a cache line;
a directory, coupled to said data array, having said M rows, each of said M rows having said 4 ways, each of said 4 ways in each of said M rows having a tag storage element for storing a tag of said cache line stored in a corresponding said line storage element of said data array, said tag storage element further configured to store 2 bits of cache line replacement information; and
an encoder, coupled to said directory, for reading 8 bits comprising said 2 bits of cache line replacement information from each of said 4 ways of a selected one of said M rows, and encoding said 8 bits into 3 bits according to a pseudo-least-recently-used encoding, wherein said 3 bits specify which of said 4 ways of said selected one of said M rows is substantially least recently used.

32. The cache of claim 31, wherein said encoder performs exclusive-OR operations on portions of said 8 bits in a predetermined manner to generate said 3 bits.

33. The cache of claim 31, further comprising:
a decoder, coupled to said directory, for generating 2 new bits of cache line replacement information for updating said one of said 4 ways of said selected one of said M rows that is substantially least recently used.

34. The cache of claim 33, wherein said decoder generates said 2 new bits based on said one of said 4 ways of said selected one of said M rows that is substantially least recently used.

35. The cache of claim 34, wherein said decoder generates said 2 new bits based further on said 2 bits of cache line replacement information from said one of said 4 ways of said selected one of said M rows that is substantially least recently used.

36. The cache of claim 31, further comprising:
a replacement way generator, coupled to said directory, for generating a signal for specifying which of said 4 ways of said selected one of said M rows is substantially least recently used based on said 3 bits.

37. An associative cache memory having an integrated tag and cache line replacement information array, comprising:
an M row by N way array of storage elements, each storage element for storing a cache line tag and per way replacement information, said array having an input for receiving an index for selecting one of said M rows of said array; and
control logic, coupled to said array of storage elements, configured to encode said per way replacement information from all of said N ways of said selected one of said M rows into per row replacement information, thereby obviating a need for a separate cache line replacement information array of storage elements.

38. The cache memory of claim 37, wherein said per row replacement information specifies which one of said N ways of said selected one of said M rows is substantially least recently used.

39. The cache memory of claim 38, wherein said control logic is further configured to update said per way replacement information in said one of said N ways that is substantially least recently used.

40. The cache memory of claim 37, wherein said control logic decodes said per way replacement information such that said per way replacement information is individually updateable without requiring update of said per way replacement information in each of said N ways of said selected one of said M rows.

41. The cache memory of claim 37, further comprising:
a second M row by N way array of storage elements, coupled to said control logic, each storage element of said second array for storing a cache line corresponding to said tag stored in said first M row by N way array of storage elements.

42. An N-way associative cache memory, comprising:
a two-dimensional tag and least-recently-used (LRU) array, each row of said array configured to store N tags in N ways of said row, each row of said array further configured to store pseudo-LRU information, said pseudo-LRU information comprising N portions distributed across said N ways of said row, said N portions collectively specifying which of said N ways is pseudo-least-recently-used, each of said N portions of said pseudo-LRU information associated with a corresponding one of said N tags and individually updateable along with said corresponding one of said N tags; and
control logic, coupled to said array, configured to receive said N portions of said pseudo-LRU information distributed across said N ways of said row, and to replace a cache line in a two-dimensional data array of the cache memory corresponding to said two-dimensional tag and LRU array, wherein said N portions specify said cache line as pseudo-least-recently-used in said row.

43. The cache memory of claim 42, wherein said N portions of said pseudo-LRU information are distributed across all said N ways of said row in a predetermined manner.

44. The cache memory of claim 42, wherein said control logic is configured to update one of said N portions of said pseudo-LRU information based on a load hit of one of said N ways storing said one of said N portions.

45. The cache memory of claim 42, wherein if one of said N ways of said row is invalid, said control logic replaces said invalid cache line rather than said pseudo-least-recently-used cache line.

46. A method for updating an associative cache having M rows and N ways, comprising the steps of:
selecting a row from said M rows of said cache based on a cache line address;
reading cache line replacement information stored in each of said N ways of said row selected;
selecting a way for replacement of said N ways of said row selected in response to said reading;
generating new cache line replacement information in response to said reading and said selecting said way; and
updating said way with said new cache line replacement information after said generating.

47. The method of claim 46, wherein said updating said way comprises updating only said way of said N ways of said row selected for replacement.

48. The method of claim 46, further comprising:
updating said way with a new cache line substantially concurrently with said updating said way with said new cache line replacement information.

49. The method of claim 46, further comprising:
updating said way with a new cache line tag substantially concurrently with said updating said way with said new cache line replacement information.

50. The method of claim 46, wherein said selecting a way for replacement comprises:
determining which of said N ways of said row selected is substantially least recently used in response to said reading said cache line replacement information stored in each of said N ways of said row selected.
